(19) United States
(12) Patent Application Publication
(10) Pub. No.: US 2020/0013052 A1
(43) Pub. Date: Jan. 9, 2020

(54) OFFLINE CRYPTOCURRENCY WALLET WITH SECURE KEY MANAGEMENT

(71) Applicant: ESMART TECH, INC., San Diego, CA (US)

(72) Inventors: Kenny Fok, San Diego, CA (US); David Chhat, San Diego, CA (US); Leroy Kuybus, Chula Vista, CA (US); Louis Nicdao, San Diego, CA (US); Jim McLaughlin, San Diego, CA (US); Abad Vera, Murrieta, CA (US); Ying Xiong, San Diego, CA (US); Andy Fok, San Diego, CA (US); Mark Parreira, Imperial Beach, CA (US)

(21) Appl. No.: 16/027,816

(22) Filed: Jul. 5, 2018

(51) Int. Cl. G06Q 20/38; H04L 9/08

(52) U.S. Cl. CPC G06Q 20/3829; G06Q 2220/00; H04L 9/0894; H04L 9/0816

(57) ABSTRACT

A method of performing cryptocurrency transactions requiring a private key includes: establishing a connection from a smart wallet to a user device; receiving a transaction request requiring the private key; disabling the connection; retrieving the private key to a private key memory; processing the transaction; clearing the private key memory; enabling the connection; and sending a completion message. A method of performing cryptocurrency transactions requiring a private key includes: establishing a connection from a user device to a smart wallet; receiving a transaction request requiring the private key; sending the transaction request to the smart wallet; determining that the smart wallet is disconnected from the user device; waiting for the smart wallet to reconnect; and receiving a response from the smart wallet. A smart wallet includes: a storage; a private key storage; and a communication module that is able to communicate with a user device across at least one channel.

### BACKGROUND

Many consumers utilize cryptocurrency to facilitate various financial transactions. Each consumer may be associated with a “wallet” that manages each cryptocurrency account. Such management may include, for instance, logging of transactions, maintaining balance information, etc.

Such wallets may typically utilize a private and public key pair. The public key may allow others to send cryptocurrency to the user associated with the public key. The private key may allow the user associated with the private key to send cryptocurrency to others.

Wallets associated with such cryptocurrency accounts may be “online” or “offline”. Online (or “hot”) wallets may generate public and private key pairs at some online entity for use in users' wallets. Such online entities may be a target for hackers as access to many account associated with many users may be achieved. Offline (or “cold”) wallets may generate public and private key pairs at an offline (i.e., unconnected) device, where the private key is retained at the offline device. Such an approach limits the

While offline wallets are not prime hacking targets, because each wallet must be individually accessed via a dedicated hardware device rather than a common resource shared by many accounts. In addition, offline wallets typically require physical access to a hardware device in order to hack an account.

Although offline wallets offer security benefits, backup and/or restore operations are cumbersome. Thus, many users may fail to take such steps and risk losing all cryptocurrency in an account if a wallet device is lost or damaged and the backup and/or restore is unsuccessful or incomplete. Typical existing solutions may display a set of phrases (e.g., twenty-four phrases) in a specified order, where users are required to provide the set of phrases in the specified order to restore a private key. Many, most, or all users may fail to properly document such phrases or other restoration criteria.

Furthermore, even if a user fulfills such requirements (e.g., by tabulating, printing, photographing, etc.) the list of phrases, backup and/or restore operations may not be secure, as the group of seed phrases are shown in unencrypted plain text format. Thus, users may fail to properly lock up, encrypt, and/or otherwise secure such recovery information. In addition, any entity that attains the list of phrases is able to restore a private key.

In addition, even “offline” wallets may require connection via a device (e.g., a personal computer, smartphone, etc.) that may expose private key information when processing cryptocurrency transactions. Existing secure solutions are cumbersome, and require users to manually enter or capture transaction information to the wallet via a keyboard, touchscreen, camera, etc.

Therefore there exists a need for secure, automated transaction processing via cryptocurrency wallets without exposing private key information.

### SUMMARY

Some embodiments may provide a smart wallet device and a smart key device for use with cryptocurrency systems.

The smart wallet device may include various physical connectors that may allow the smart wallet to interact with the smart key device and/or various user devices (e.g., smartphones, tablets, personal computers, etc.). In addition, the smart wallet device may include displays and/or other user interface elements that may provide authentication information (and/or other information) to a user associated with the smart wallet device. The smart wallet device may further include various input elements (e.g., buttons, keys, touchscreens, etc.) that may be able to receive user inputs. The smart wallet device may include a local storage that is able to store various public and private encryption keys that may be used for authentication of cryptocurrency transactions.

The smart wallet may be associated with a personal identification number (PIN) or passcode that is set by a user. The PIN may be required to be entered (and validated) at the wallet in order to unlock the wallet such that transactions may be processed via the wallet.

The smart key device may include various physical connectors that may allow the smart key device to interact with the smart wallet device. In addition, the smart key device may include a local storage that may be able to store various public and private encryption keys. The local storage may be at least partly controlled by a state of the smart key device. In an unlocked state, data may be written to the local storage, while in a locked state, the local storage may be read only.

The smart wallet device may be able to provide and/or generate various public and private key pairs including a wallet key pair (a private wallet key and a public wallet key) and a transaction key pair (a private transaction key and a public transaction key).

The smart key device may be able to provide and/or generate a key device key pair (a private key device key and a public key device key).

During backup, the smart wallet device may encrypt the private transaction key and PIN using the public key device key and send the encrypted key and PIN to the smart key device. The smart key device may decrypt the encrypted key and PIN using the private key device key, encrypt the private transaction key and PIN using the public wallet key, and store the encrypted key and PIN.

During restore, the smart wallet may retrieve the encrypted key and PIN (encrypted using the public wallet key) and decrypt the key and PIN using the private wallet key in order to restore the unencrypted private transaction key and PIN.

When processing transactions that require the private key, the smart wallet may disconnect from any other devices (e.g., a user device) when accessing and/or utilizing the private key. The private key may be placed in a dedicated memory or memory location. Such memory may be wiped or cleared after using the private key. The smart wallet may then reconnect to the user device in order to complete the transaction. Such an approach ensures that the private key is not accessible when the smart wallet is connected to any other device and is thus not exposed.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates a schematic block diagram of a secure wallet system according to an exemplary embodiment;

FIG. 2 illustrates a schematic block diagram of a smart wallet device and smart key device included in the system of FIG. 1;

FIG. 3 illustrates a schematic block diagram of an offline smart wallet system of some embodiments;

FIG. 4 illustrates a flow chart of an exemplary process that generates a private wallet key used by the system of FIG. 1;

FIG. 5 illustrates a flow chart of an exemplary process that stores the private wallet key at a smart key device used by the system of FIG. 1;

FIG. 6 illustrates a flow chart of an exemplary process that restores a private wallet key from a smart key device to a smart wallet device used by the system of FIG. 1;

FIG. 7 illustrates a flow chart of an exemplary process that facilitates secure wallet transactions using the system of FIG. 1;

FIG. 8 illustrates a flow chart of an exemplary user device process that facilitates secure wallet transactions using the system of FIG. 1; and

FIG. 9 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a smart cryptocurrency wallet device that is able to process transactions without exposing private key information.

A first exemplary embodiment may provide a method of performing cryptocurrency transactions requiring a private key, the method comprising: establishing a connection from a smart wallet device to a user device; receiving, at the smart wallet device, a transaction request requiring the private key; disabling the connection; retrieving the private key to a private key memory; processing the transaction; clearing the private key memory; enabling the connection; and sending a completion message from the smart wallet device to the user device. The transaction request may include information such as a transaction amount, type of cryptocurrency, receipt address, etc.

A second exemplary embodiment may provide a method of performing cryptocurrency transactions requiring a private key, the method comprising: establishing a connection from a user device to a smart wallet device; receiving, at the user device, a transaction request requiring the private key; sending the transaction request to the smart wallet device; determining that the smart wallet device is disconnected from the user device; waiting for the smart wallet device to reconnect; and receiving a response from the smart wallet device. The transaction request may include information such as a transaction amount, type of cryptocurrency, receipt address, etc.

A third exemplary embodiment may provide a smart cryptocurrency wallet device comprising: a local storage; a private key storage; and a communication module that is able to communicate with a user device across at least one channel.

Several more detailed embodiments are described in the sections below. Section I provides a description of a system architecture used by some embodiments. Section II then describes various methods of operation implemented by some embodiments. Lastly, Section III describes a computer system which implements some of the embodiments.

### I. System Architecture

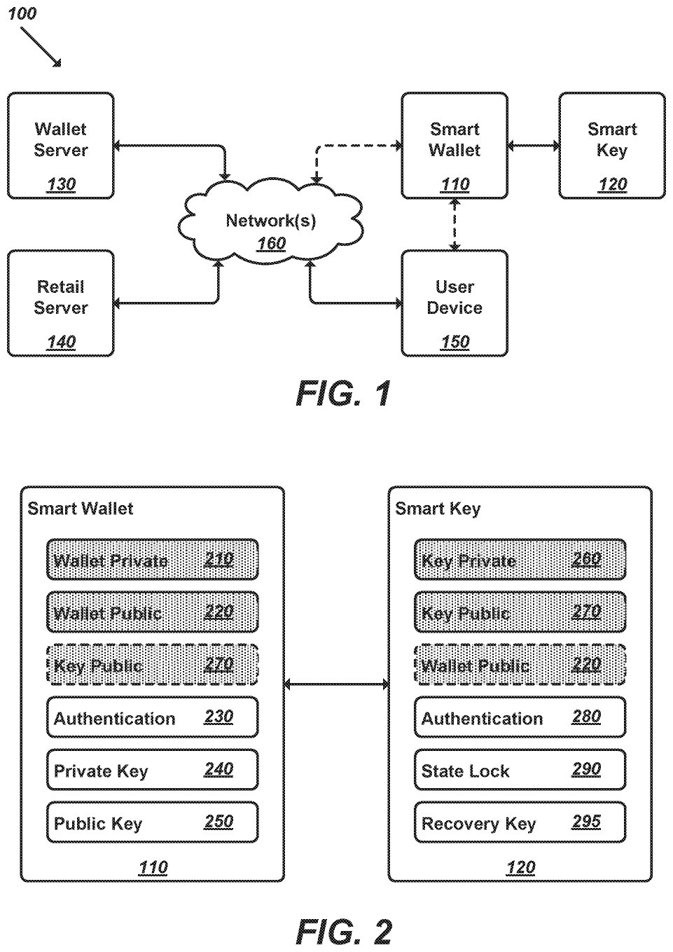

FIG. 1 illustrates a schematic block diagram of a secure wallet system 100 according to an exemplary embodiment. As shown, the system 100 may include a smart wallet 110, a smart key 120, a wallet server 130, a retail server 140, a user device 150, and a set of networks 160.

Each smart wallet 110 may be a computing device able to store and process data. The smart wallet may be associated with one or more cryptocurrency accounts. The smart wallet may allow secure cryptocurrency transactions through the use of private and public key pairs. The smart wallet may be able to generate a public and private key pair. The smart wallet may be able to interact with the smart key 120 and various user devices 150, as appropriate, via one or more physical connections (e.g., a “key interface”). The smart wallet 110 may an offline smart wallet that is not connected to the network 160. The smart wallet 110 may receive firmware updates from a server 130 associated with the wallet service.

In some embodiments, the smart wallet 110 may include various user interface features (e.g., displays, speakers, etc.) such that the wallet is able to provide authentication information (and/or other information such as user prompts) as needed. For instance, the wallet may display a changing key that is synchronized to a wallet server 130 such that a user may be able to validate a transaction by supplying the key displayed at the wallet 110. Alternatively, such information may be provided automatically via the user device 150 such that the wallet server 130 and/or retail server 140 receive appropriate transaction confirmation. In addition, the wallet may include various user interface elements that may allow a user to select various modes, options, etc. Such elements may include, for instance, buttons, keypads, touchscreens, microphones, etc.

Each smart key 120 may be an electronic device capable of storing and/or processing data. The smart key may have a locking feature such that the key is able to change from an unlocked state to a locked state after a private key is provided by the smart wallet 110. When the key 120 is changed to a locked state, the device may become read-only such that the key is not able to be modified. In addition, the locked state may include a permanent modification such that the smart key is not able to transition back to an unlocked state after initially being locked. The smart key may be able to generate a public and private key pair. The smart key may be able to interact with the smart wallet 110. Such interaction may be limited to a physical connection (e.g., a universal serial bus or “USB” connection).

Each wallet server 130 (and/or collection of servers) may be an electronic device that is able to execute instructions and/or otherwise process data. The server may specifically facilitate cryptocurrency transactions associated with the smart wallet 110 account. The server may be accessed via an application programming interface (API) and/or other appropriate resource. The server 130 may be associated with a particular cryptocurrency service or technology.

Each retail server 140 and/or other third-party resource may be able to interact with the wallet server 130, user device 150, and/or other appropriate elements in order to administer various cryptocurrency transactions. The server 140 may be able to interact with various cryptocurrency services or technologies.

Each user device 150 may be an electronic device able to execute instructions and/or otherwise process data. The user device may include various user interface elements that may allow user interaction. The user device may be a device such as a smartphone, tablet, personal computer, television, wearable device, etc.

The networks 160 may include various wired and/or wireless communication pathways among the various system elements. Such networks may include, for instance, Ethernet, Wi-Fi, cellular, Bluetooth, the Internet, etc.

During operation, a user may utilize the user device 150 (via one or more applications, web browsers, etc.) to initiate and/or react to a cryptocurrency event. Such events may include, for instance, sending an invoice, receiving payments, delivering payment, authorizing a debit, etc. The event may require private key validation (e.g., as when funds are removed from the user's account). Such an event may prompt the user to enter private key encoded information (e.g., by entering a PIN or passcode via wallet 110). The private key encoded information may be provided by the smart wallet. The wallet server 130 may validate the private key encoded information and process the transaction (or reject the transaction as appropriate).

FIG. 2 illustrates a schematic block diagram of a smart wallet device 110 and smart key device 120 included in the system 100. The wallet 110 and key 120 may be paired devices that are specifically associated to each other (e.g., via matching or associated keys, protocols, etc.). As shown, the smart wallet 110 may include a wallet private key 210, a wallet public key 220, an authentication module 230, a private key 240, and a public key 250. The smart key may include a key private key 260, a key public key 270, an authentication module 280, a state lock 290, and a recovery key 295. In addition, the smart wallet 110 may include a copy of the smart key public key 270 and the smart key 120 may include a copy of the wallet public key 220. Each device may further include various appropriate elements omitted for clarity and brevity (e.g., power sources, user interface elements, storages, etc.).

The wallet private key 210 may be paired to the wallet public key 220. The wallet private key 210 may not be shared to any other resource, while the wallet public key 220 may be freely distributed to other resources. The keys 210 and 220 may be provided and/or generated by the smart wallet 110. As described above, the public key 220 may be used for encryption while the private key 210 may be used for decryption. The wallet key pair 210-220 and key public key 270 may be used for secure communication between the wallet 110 and the smart key 120. Some embodiments may utilize other secure protocols, such as advanced encryption standard (AES). The wallet key pair 210-220 and key public key 270 may be preloaded into the firmware of the wallet 110, as indicated by the fill pattern.

The wallet authentication module 230 may include information associated with various authentication protocols. For instance, such information may include handshake information such as validation criteria, lists of elements, etc. The module 230 may be able to interact with the smart key 120 in order to validate the smart key and/or smart wallet 110 information.

The private key (or “private transaction key”) 240 may be paired to the public key (or “public transaction key”) 250. The private key 240 may not be shared to any other resource, while the public key 250 may be freely distributed to other resources. The keys 240 and 250 may be generated by the smart wallet 110. As described above, the public key 250 may be used for wallet deposits while the private key 240 may be used for payments with the cryptocurrency system associated with the wallet 110. The key pair 240-250 may be used for secure cryptocurrency transactions. Any stored version of the private key 240 may have been previously encrypted using the wallet public key 220 and/or other encryption protocols or algorithms.

The key private key 260 may be paired to the key public key 270. The key private key 260 may not be shared to any other resource, while the key public key 270 may be freely distributed to other resources. The keys 260 and 270 may be provided and/or generated by the smart key 120. As described above, the public key 270 may be used for encryption while the private key 260 may be used for decryption. The key pair 260-270 associated with the smart key 120 and the wallet public key 220 may be used for secure communication between the wallet 110 and the smart key 120. The key pair 260-270 associated with the smart key 120 and the wallet public key 220 may be preloaded into firmware of the smart key 120, as indicated by the fill pattern.

The key authentication module 280 may include information associated with various authentication protocols. For instance, such information may include handshake information such as validation criteria, lists of elements, etc. The module 280 may be able to interact with the smart wallet 110 in order to validate the smart wallet and/or smart key 120 information.

The state lock 290 may be able to permanently fix the memory of the smart key such that the device is not writable after initially saving a recovery key 295. The state lock 290 may also be able to provide an indication to the smart wallet as to the current state of the key 120 (i.e., “locked” or “unlocked”).

The recovery key 295 may be an encrypted version of the private key 240 that is able to be used to recover the unencrypted private key 240 to the wallet 110.

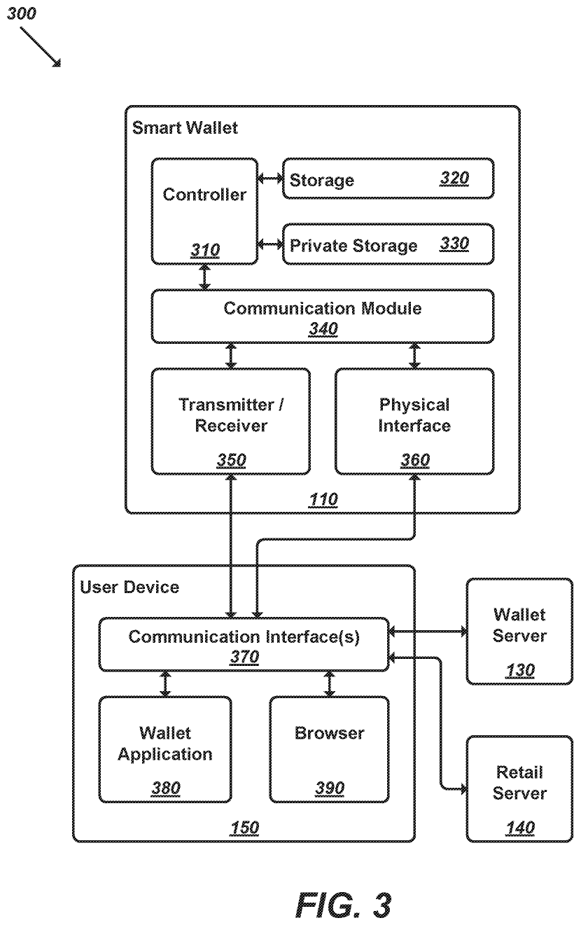

FIG. 3 illustrates a schematic block diagram of an offline smart wallet system 300 of some embodiments. As shown, the system may include a smart wallet 110, a user device 150, a wallet server 130, and/or a retail server 140. This system is referred to as an “offline” system, even though the user device 150 may be a network-connected device, because the wallet does not include online connectivity (e.g., a network connection to either server 130 or 140).

The smart wallet 110 may include a controller 310, a storage 320, a private storage 330, a communication module 340, a transmitter/receiver 350, and a physical interface 360. The user device may include a communication interface 370, a wallet application 380, and/or a browser 390.

The controller 310 may be an electronic device that is able to execute instructions and/or otherwise process data. The controller may be able to at least partly direct operations of other device elements.

The storage 320 may be an electronic device capable of storing data and/or instructions. The private storage 330 may be a separate device or a specified region of storage 320. The private storage 330 may be “wiped” (i.e., cleared and/or written with random data) whenever the smart wallet 110 is connected to a user device 150 such that private key data is not exposed outside the wallet. Either or both storages 320-330 may be embedded in the controller 310 in some embodiments.

The communication module 340 may be able to direct interactions with the user device 150 via the wireless resources 350 and/or physical connection interface(s) 360. The communication module 340 may be able to completely disable the resources 350 and 360 (e.g., by removing power supplied to those elements) such that no external communication is possible. In some embodiments, the communication module 340 may be embedded in the controller 310.

The transmitter/receiver 350 may be able to communicate across various appropriate wireless channels (e.g., Bluetooth, Wi-Fi, etc.).

The physical interface 360 may be able to communicate across various physical connections (e.g., a USB connection).

The communication interface 370 may be able to communicate with the smart wallet 110 using various wired and/or wireless communication resources.

The wallet application 380 may be a dedicated application associated with a particular cryptocurrency (or set of cryptocurrencies) and/or with the smart wallet 110. Such an application 380 may allow a user to perform various transactions (e.g., send money, receive money, etc.).

The browser 390 may allow users to connect to the smart wallet 110 without needing a dedicated application 380. In some embodiments, however, the communication interface 370 may use a proprietary protocol when communicating with the transmitter/receiver 350 or physical interface 360, where such a proprietary protocol is implemented by the wallet application 380.

One of ordinary skill in the art will recognize that systems 100 and 300 may be implemented in various different ways without departing from the scope of the disclosure. For instance, different embodiments may include different numbers of instantiations of each system element or device (e.g., the system may include multiple servers, wallets, etc.). As another example, the components may have various other communication pathways than shown. Further, various additional components may be included and/or various listed components may be omitted.

### II. Methods of Operation

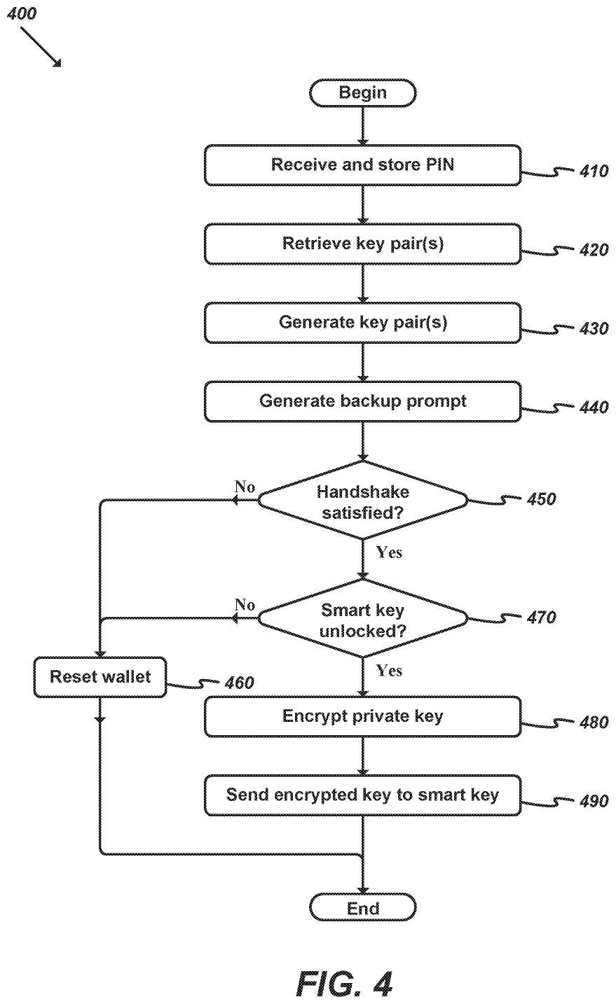

FIG. 4 illustrates a flow chart of an exemplary process 400 that generates a private wallet key used by the system 100. Such a process may be executed by the smart wallet 110 of some embodiments. The smart key 120 may execute a complementary process, such as process 500. Process 400 may begin, for instance, when a user activates a smart wallet 110 of some embodiments.

As shown, the process may receive (at 410) a personal identification number (PIN) or passcode. The PIN may be encrypted and stored at the wallet (e.g., at authentication module 230). A user may be required to entire the PIN in order to authenticate transactions performed via the wallet.

Next, the process may retrieve (at 420) one or more keys and/or key pairs (e.g., pair 210-220, key public key 270). Such key pairs may be generated in various appropriate ways, using various appropriate algorithms. The keys and/or key pairs may be pre-loaded into firmware of the wallet 110. The process may encrypt and store the private key 240 (e.g., using the key public key 270) at a local storage of the smart wallet 110.

The process may generate (at 43) one or more key pairs (e.g., pair 240-250) at the wallet 110. Such key pairs may be generated in various appropriate ways, using various appropriate algorithms.

The process may then generate (at 440) a backup prompt. The backup prompt may utilize various user interface elements of the wallet (e.g., a display screen) to indicate that the smart key 120 should be connected to the smart wallet 110 (e.g., by providing a message such as “connect key to wallet”). Such a connection may be made via USB or other appropriate physical interface. The process may be able to automatically detect that a key 120 has been connected to the wallet 110.

Process 400 may then determine (at 450) whether a handshake or other authentication criteria have been satisfied. If the process determines (at 450) that the criteria have not been satisfied, the process may reset (at 460) the wallet and then may end. Such a reset may include resetting state information (and/or other information) associated with the wallet 110 and/or key 120 such that the process may be restarted.

During the handshake (and/or other appropriate times), the key 120 may send the key public key 270 to the wallet 110 (and/or the wallet may retrieve the key public key 270). Likewise, the wallet 110 may send the wallet public key 220 to the smart key device 120 (and/or the key device may retrieve the wallet public key 220). Alternatively, as described above, the keys 270 and 220 may be pre-loaded into the firmware of both devices 110 and 120.

If the process determines (at 450) that the handshake was successful, the process may determine (at 470) whether the smart key 120 is in an unlocked state. Such a determination may be made by retrieving state lock data 290 from the key 120. If the process determines (at 470) that the key 120 is not unlocked (i.e., that the key was previously used for backup), the process may end. Operations 450 and 470 may together provide “authentication” of a smart key 120 that is physically connected to the wallet 110.

If the process determines (at 470) that the key 120 is in an unlocked state, the process may encrypt (at 480) the private key 240 using the key public key 270, send (at 490) the encrypted key 295 to the smart key device 120 and then may end. In addition, the PIN or passcode may be encrypted and sent to the smart key device 120 In addition to the encrypted key, the process may send the wallet public key 220 to the smart key device 120.

In some embodiments, process 400 may verify that the encrypted key was successfully received by determining that the state of the smart key device 120 has changed to “locked” within a specified time. After verification of the state change, the process may provide an indication via the wallet user interface elements (e.g., by displaying a message such as “backup complete”).

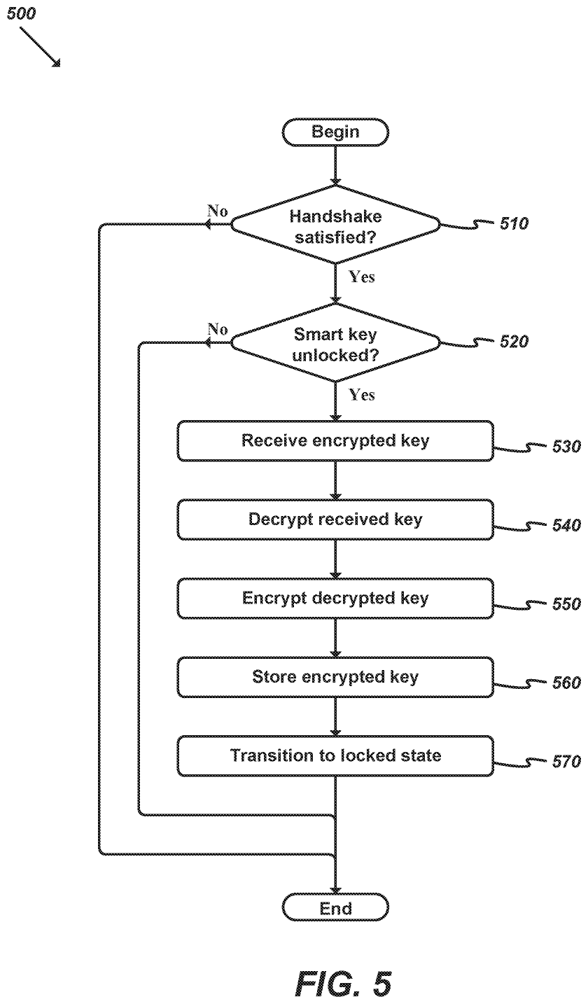

FIG. 5 illustrates a flow chart of an exemplary process 500 that stores the private wallet key at a smart key device 120 used by the system 100. Such a process may be executed by the smart key 120 of some embodiments. The smart wallet 110 may execute a complementary process, such as process 400. Process 500 may begin, for instance, when a smart key 120 is connected to a smart wallet 110.

As shown, the process may determine (at 510) whether the handshake or other authentication criteria have been satisfied. If the process determines (at 510) that the handshake has not been successful, the process may end.

If the process determines (at 510) that the handshake was successful, the process may determine (at 520) whether the smart key 120 is locked. Such a determination may be made by retrieving state lock data 290 stored at the key 120. If the process determines (at 520) that the smart key 120 is not unlocked, the process may end.

If the process determines (at 520) that the smart key 120 is unlocked, the process may receive (at 530) the encrypted key provided by the wallet 110 at 370, where the encrypted key was encrypted with key public key 270. Likewise, the encrypted PIN or passcode may also be received at the smart key 120.

Next, process 500 may decrypt (at 540) the received key using the smart key private key 260. The process may then encrypt (at 550) using the smart wallet public key 220.

Process 500 may then store (at 560) the encrypted key 295 at internal storage of the smart key device 120. Finally, the process may transition (at 570) to the locked state and then may end.

As described above, the process may further send a confirmation to the wallet 110 in some embodiments.

After performing the key backup, a user may install various wallet applications (and/or access such applications via a resource such as a web browser) to a user device 150 that may utilize data provided by the smart wallet 110.

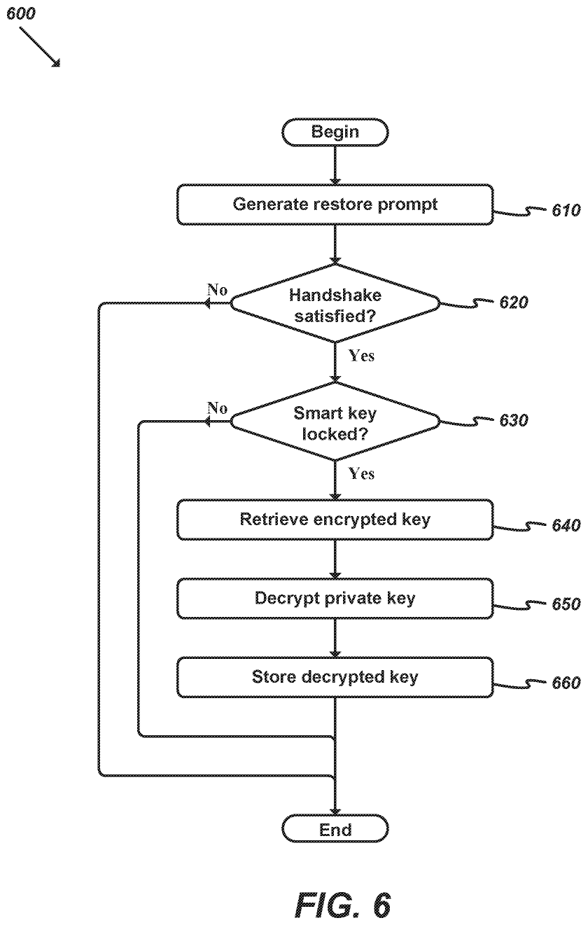

FIG. 6 illustrates a flow chart of an exemplary process 600 that restores a private wallet key from a smart key device 120 to a smart wallet device 110 used by the system 100. Such a process may be executed by the smart wallet 110 of some embodiments. The smart key 120 may execute a complementary process. Process 600 may begin, for instance, when a user initiates a restore operation using a smart wallet 110 of some embodiments.

As shown, the process may generate (at 610) a restore prompt. Such a prompt may include a display of an appropriate message (“insert smart key”). Next, the process determines (at 620) whether the handshake has been satisfied. If the process determines (at 620) that the handshake has not been satisfied, the process may end.

If process 600 determines (at 620) that the handshake has been satisfied, the process may determine (at 630) whether the smart key device is in a locked state. If the process determines (at 630) that the smart key is not locked, the process may end.

If the process determines (at 630) that the smart key 120 is in a locked state, the process may retrieve (at 640), at the wallet 110, the encrypted key 295 stored in the local storage of the smart key 120. In addition, the encrypted PIN or passcode may also be retrieved.

Next, the process may decrypt (at 650), at the wallet 110, the encrypted key using the wallet private key 210. The process may then encrypt (e.g., using key public key 270) and store (at 660) the decrypted private key 240 at the wallet 110 and then may end.

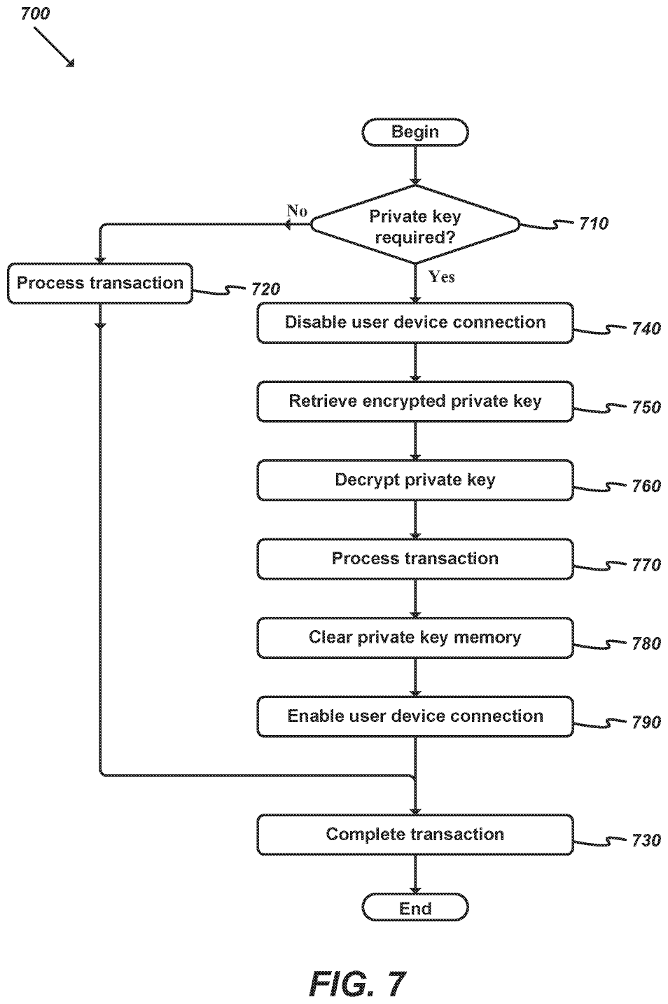

FIG. 7 illustrates a flow chart of an exemplary process 700 that facilitates secure wallet transactions using the system 100. Such a process may be executed by the smart wallet 110 of some embodiments. The user device 150 may execute a complementary process (e.g., process 800). Process 700 may begin, for instance, when a user connects a user device 150 to a smart wallet 110 of some embodiments and initiates a cryptocurrency transaction. Such connection may involve various authentication algorithms (e.g., a handshake, verification of user information, etc.), while the transaction may include receipt of funds, withdrawal of funds, etc. related to a purchase, sale, or other appropriate transaction.

As shown, the process may determine (at 710) whether a private key is required for the requested transaction. Typically, withdrawals may require a private key while deposits may not. If the process determines (at 710) that a private key is not required, the process may process (at 720) the transaction. Such processing may involve various calculations, decryptions, encryptions, etc. Next, the process may complete (at 730) the transaction and then may end. Transaction completion may involve different elements depending on the particular transaction scenario. For instance, accepting a deposit may require a confirmation message or the like. In some cases, a deposit or similar transaction may be processed at the smart wallet and the transaction completion may include a simple message indicating receipt of the transfer request.

If the process determines (at 710) that the private key is required for the requested transaction, the process may disable (at 740) the user device connection. Such disablement may include sending a message or command to the communication module 340, transmitter/receiver 350, and/or the physical interface 360. In some cases, disablement may include gating (i.e., removing) power to the appropriate resource such that communication is not possible over the channel. In this way, the private key is not exposed during use.

Next, the process may retrieve (at 750) the private key 240 previously encrypted with the wallet public key 220 (and/or other encryption protocols or algorithms) and stored at the wallet 110. The process may then decrypt (at 760) the private key 240 using the wallet private key 210.

Next, the process may process (at 770) the requested transaction. As above, such processing may involve various calculations, decryptions, encryptions, etc. In this case, at least some such actions require use of the private key 240.

The process may then clear (at 780) the private key memory 330. Such clearing may include deleting stored data, storing random data, and/or other appropriate actions that prevent exposure of the private key 240. In some embodiments, the private key memory 330 may be able to be disabled (e.g., by gating power) such that the memory is not accessible or returns a default value.

Next, the process may enable (at 790) the user device connection. Such enablement may involve, for example, powering on the transmitter 350 and/or physical interface 360.

Process 700 may then complete (at 730) the requested transaction by sending a completion message to the user device 150 and then may end. Such a completion message may include one or more values calculated and/or accessed using the private key 240. The user device 150 may then relay such information to an appropriate online resource such as a wallet server 130, retail server 140, etc.

Although process 700 has been described with respect to a user device connection, one of ordinary skill in the art will recognize that a similar process may be used to allow the wallet to connect to various other resources (e.g., a server).

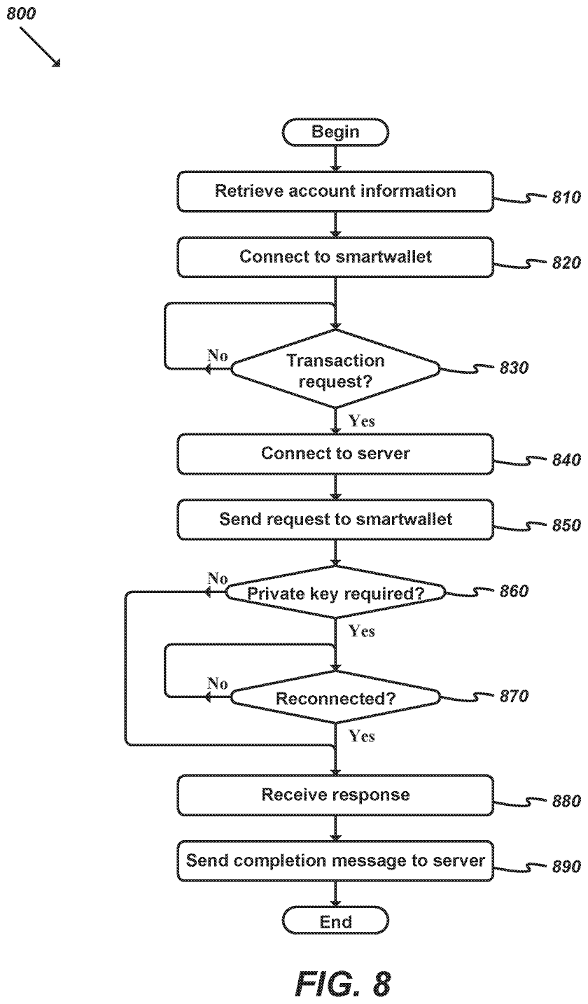

FIG. 8 illustrates a flow chart of an exemplary user device process 800 that facilitates secure wallet transactions using the system 100. Such a process may be executed by a user device 150 of some embodiments. A smart wallet 110 may execute a complementary process (e.g., process 700). Process 800 may begin, for instance, when a user launches a wallet application of some embodiments at a user device 150 (and/or otherwise connects to a cryptocurrency resource). Such launch or connection may involve various authentication algorithms (e.g., a handshake, verification of user information, etc.).

As shown, the process may retrieve (at 810) account information. Such information may include, for instance, identification of a wallet service, user identity information, authentication information, etc. Next, the process may connect (at 820) to the smart wallet 110 of some embodiments. Such a connection may be wired or wireless, as appropriate.

Next, the process may determine (at 830) whether a transaction request has been received. Such a determination may be made in various appropriate ways based on various appropriate criteria. For instance, a user may initiate a purchase at a retail site, which may send a withdrawal request. As another example, a user may initiate a subscription or installment payment using an application of some embodiments.

If the process determines (at 830) that no transaction request has been received, the process may repeat operation 830 until the process determines (at 830) that a transaction request has been received. If the process determines (at 830) that a transaction request has been received, the process may connect (at 840) to a wallet server 130 of some embodiments.

Next, the process may send (at 850) a transaction request to the smart wallet 110 of some embodiments. Such a request may include, for instance, a transaction type (e.g., deposit, withdrawal, etc.), cryptocurrency type, transaction amount, recipient address (and/or other appropriate identifying information), and/or other appropriate information (e.g., description, quantities, etc.).

Process 800 may then determine (at 860) whether a private key is required to process the transaction. As discussed about, a private key may typically be required to withdraw funds from the wallet.

If the process determines (at 860) that a private key is required, the process may expect the smart wallet to disable any communication connection and then may determine (at 870) whether the wallet has reconnected to the user device. The process may repeat operation 870 (e.g., at regular intervals) until the process determines (at 870) that the wallet has reconnected (in some embodiments, the process may end if a response timeout period is exceeded).

After the process determines (at 870) that the smart wallet is reconnected, or after determining (at 860) that the private key is not required, the process may receive (at 880) a response from the smart wallet. In some embodiments, the received response may indicate that the wallet is reconnected. The response may include various calculations and/or other information related to transaction completion.

After receiving (at 880) the response, the process may send (at 890) a completion message to the appropriate resource (e.g., server 130 or 140) and then may end. The completion message may include calculated values, keys, and/or other appropriate information.

One of ordinary skill in the art will recognize that processes 400-800 may be implemented in various different ways without departing from the scope of the disclosure. For instance, each process may include additional operations and/or omit various listed operations. The operations may be performed in different orders, iteratively, and/or based on some criteria. Each process may be divided into multiple sub-processes and/or combined into a macro process.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

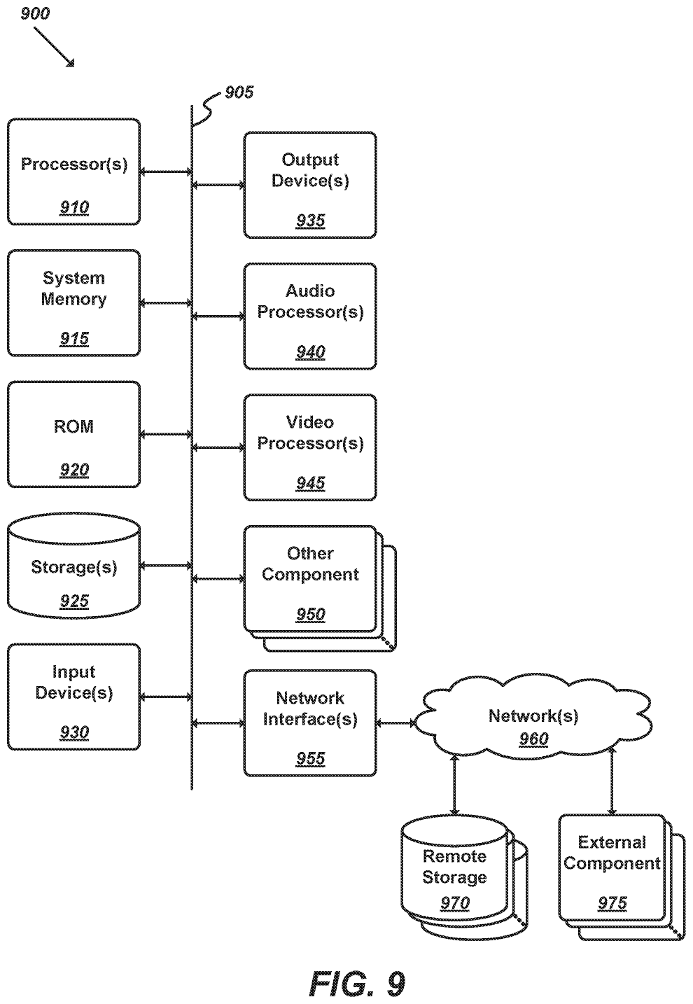

FIG. 9 illustrates a schematic block diagram of an exemplary computer system 900 used to implement some embodiments. For example, the system described above in reference to FIG. 1 may be at least partially implemented using computer system 900. As another example, the processes described in reference to FIG. 4-FIG. 8 may be at least partially implemented using sets of instructions that are executed using computer system 900.

Computer system 900 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 900 may include at least one communication bus 905, one or more processors 910, a system memory 915, a read-only memory (ROM) 920, permanent storage devices 925, input devices 930, output devices 935, audio processors 940, video processors 945, various other components 950, and one or more network interfaces 955.

Bus 905 represents all communication pathways among the elements of computer system 900. Such pathways may include wired, wireless, optical, and/or other appropriate communication pathways. For example, input devices 930 and/or output devices 935 may be coupled to the system 900 using a wireless connection protocol or system.

The processor 910 may, in order to execute the processes of some embodiments, retrieve instructions to execute and/or data to process from components such as system memory 915, ROM 920, and permanent storage device 925. Such instructions and data may be passed over bus 905.

System memory 915 may be a volatile read-and-write memory, such as a random access memory (RAM). The system memory may store some of the instructions and data that the processor uses at runtime. The sets of instructions and/or data used to implement some embodiments may be stored in the system memory 915, the permanent storage device 925, and/or the read-only memory 920. ROM 920 may store static data and instructions that may be used by processor 910 and/or other elements of the computer system.

Permanent storage device 925 may be a read-and-write memory device. The permanent storage device may be a non-volatile memory unit that stores instructions and data even when computer system 900 is off or unpowered. Computer system 900 may use a removable storage device and/or a remote storage device as the permanent storage device.

Input devices 930 may enable a user to communicate information to the computer system and/or manipulate various operations of the system. The input devices may include keyboards, cursor control devices, audio input devices and/or video input devices. Output devices 935 may include printers, displays, audio devices, etc. Some or all of the input and/or output devices may be wirelessly or optically connected to the computer system 900.

Audio processor 940 may process and/or generate audio data and/or instructions. The audio processor may be able to receive audio data from an input device 930 such as a microphone. The audio processor 940 may be able to provide audio data to output devices 940 such as a set of speakers. The audio data may include digital information and/or analog signals. The audio processor 940 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 945 (or graphics processing unit) may process and/or generate video data and/or instructions. The video processor may be able to receive video data from an input device 930 such as a camera. The video processor 945 may be able to provide video data to an output device 940 such as a display. The video data may include digital information and/or analog signals. The video processor 945 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 950 may perform various other functions including providing storage, interfacing with external systems or components, etc.

Finally, as shown in FIG. 9, computer system 900 may include one or more network interfaces 955 that are able to connect to one or more networks 960. For example, computer system 900 may be coupled to a web server on the Internet such that a web browser executing on computer system 900 may interact with the web server as a user interacts with an interface that operates in the web browser. Computer system 900 may be able to access one or more remote storages 970 and one or more external components 975 through the network interface 955 and network 960. The network interface(s) 955 may include one or more application programming interfaces (APIs) that may allow the computer system 900 to access remote systems and/or storages and also may allow remote systems and/or storages to access computer system 900 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 900 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

1. A method of performing cryptocurrency transactions requiring a private key from a smart wallet, the method comprising:
establishing a connection from the smart wallet device to a user device;
receiving, at the smart wallet device, a transaction request from the user device requiring the private key;
disabling in the smart wallet, a communication connection between the smart wallet and the user device to prevent external access to memory of the smart wallet;
retrieving the private key stored in the smart wallet and sending it to a private key memory of the smart wallet;
authorizing in the smart wallet the transaction using the private key in the private key memory of the smart wallet;
clearing the private key memory;
enabling the communication connection; and
sending a transaction completion message from the smart wallet device to the user device.

2. The method of claim 1 further comprising decrypting the private key using a smart wallet private key.

3. The method of claim 1, wherein the private key is associated with a cryptocurrency account.

4. The method of claim 1 wherein clearing the private key memory comprises writing random data to the private key memory.

5. The method of claim 1, wherein authorizing the transaction comprises performing at least one calculation using the private key.

6. The method of claim 1, wherein disabling the communication connection comprises gating power to at least one of a transmitter, receiver, and physical interface.

7. The method of claim 1, wherein the transaction request comprises at least one of an amount, a type of cryptocurrency, and a receipt address.

8. A method of performing cryptocurrency transactions requiring a private key from a smart wallet, the method comprising:
establishing a communication connection from a user device to a smart wallet device;
receiving, at the user device, a transaction request requiring the private key;
sending the transaction request to the smart wallet device;
determining that the smart wallet device is disconnected from the user device, wherein the disconnection is due to the smart wallet disconnecting the communication connection between the smart wallet and the user device to prevent external access to memory of the smart wallet;
waiting for the smart wallet device to reconnect with the user device, wherein the smart wallet has either authorized or unauthorized the transaction request while disconnected from the user device; and
receiving, at the user device, a response from the smart wallet device.

9. The method of claim 8 further comprising sending the response to a server.

10. The method of claim 8, wherein the response comprises at least one calculation performed using the private key.

11. The method of claim 8, wherein establishing the communication connection comprises launching a wallet application at the user device.

12. The method of claim 8, wherein the smart wallet device and the private key are associated with a cryptocurrency account.

13. The method of claim 8, wherein the transaction request is received from a server.

14. The method of claim 8, wherein the transaction request comprises at least one of an amount, a type of cryptocurrency, and a receipt address.

15. A smart cryptocurrency wallet device comprising:
a local storage;
a private key storage; and
a communication module that is able to communicate with a user device across at least one channel.

16. The smart cryptocurrency wallet device of claim 15, wherein the private key storage is wiped when the at least one channel is enabled.

17. The smart cryptocurrency wallet device of claim 15, wherein the at least one channel is disabled when a private key is stored in the private key storage.

18. The smart cryptocurrency wallet device of claim 17, wherein an encrypted version of the private key is stored in the local storage.

19. The smart cryptocurrency wallet device of claim 18, wherein the encrypted version of the private key is decrypted before the private key is placed in the private key storage.

20. The smart cryptocurrency wallet device of claim 15, wherein the at least one channel comprises at least one of a wireless connection and a wired connection.
